(19) United States
(12) Patent Application Publication
(10) Pub. No.: US 2013/0094025 A1
(43) Pub. Date: Apr. 18, 2013

(54) COMPONENT CONCENTRATION MEASUREMENT DEVICE AND COMPONENT CONCENTRATION MEASUREMENT METHOD

(71) Applicants: Kazuhiro NISHIDA, Matsumoto (JP); Koichi SHIMIZU, Sapporo (JP)

(72) Inventors: Kazuhiro NISHIDA, Matsumoto (JP); Koichi SHIMIZU, Sapporo (JP)

(73) Assignees: NATIONAL UNIVERSITY CORPORATION HOKKAIDO UNIVERSITY, Sapporo (JP); SEIKO EPSON CORPORATION, Tokyo (JP)

(21) Appl. No.: 13/609,456

(22) Filed: Sep. 11, 2012

(30) Foreign Application Priority Data
Oct. 17, 2011 (JP) 2011-227932

(51) Int. Cl. G01N 21/59

(52) U.S. Cl. 356/432

(57) ABSTRACT

Light emitted from a light source section is split into measurement light and gate light by a splitter section. The measurement light is applied to an object by an irradiation section. Emitted light from the object is condensed by a condenser section, and relayed to a light conversion section by a relay section. The gate light obtained by the splitter section is guided to an optical shutter section. In this case, the gate light is changed in optical path length by a gate light guide section, and guided to a Kerr material section. A time-resolved waveform is calculated from a light intensity detection result at the optical path length that has been changed, and the concentration of a component contained in the object is calculated.

Japanese Patent Application No. 2011-227932 filed on Oct. 17, 2011, is hereby incorporated by reference in its entirety.

### BACKGROUND

A concentration measurement method that measures the concentration of a component contained in an object (subject) has been developed.

For example, a method that measures the blood glucose level using a human skin as the object has been developed. The blood glucose level has been measured by collecting blood from a fingertip or the like, and measuring the enzymatic activity against glucose in blood.

However, it is necessary to collect blood from a fingertip or the like when using the above blood glucose level measurement method. Specifically, the above blood glucose level measurement method is invasive, and is painful or unpleasant for the subject. In order to deal with this problem, a method that applies near-infrared light to part (e.g., the surface of a hand) of a human body, and measures the blood glucose level from the light absorption has been developed as a non-invasive blood glucose level measurement method.

For example, JP-A-2010-237139 discloses a technique that calculates the concentration of glucose contained in the dermis layer by utilizing a time-resolved waveform of reflected light from the skin. JP-A-2004-219426 and JP-A-2001-133396 disclose a method that measures a time-resolved waveform using a streak camera.

### SUMMARY

According to one aspect of the invention, there is provided a component concentration measurement device comprising:

an irradiation section that applies measurement light to an object, the measurement light being pulsed light;

a condenser section that condenses emitted light from the object;

a detection section that detects light intensity;

a gate light guide section that guides gate light, and is configured so that an optical path length can be changed, the gate light being pulsed light that is synchronized with the measurement light;

an optical shutter section that allows light that has been condensed by the condenser section to pass through toward the detection section based on the gate light guided by the gate light guide section;

an optical path length control section that changes the optical path length of the gate light guide section; and

a calculation section that calculates a time-resolved waveform from a detection result of the detection section, and calculates a concentration of a component contained in the object.

According to another aspect of the invention, there is provided a component concentration measurement method comprising:

guiding pulsed light that is synchronized with measurement light to an optical shutter section as gate light, the measurement light being pulsed light, and the optical shutter section allowing emitted light from an object when the measurement light has been applied to the object to pass through based on the gate light;

changing an optical path length of the gate light that is guided to the optical shutter section;

detecting intensity of light that has passed through the optical shutter section; and

calculating a time-resolved waveform from the intensity of the light detected while changing the optical path length, and calculating a concentration of a component contained in the object.

### BRIEF DESCRIPTION OF THE DRAWINGS

FIG. 1 is a block diagram illustrating an example of a functional configuration of a component concentration measurement device.

FIG. 2 is a view illustrating an example of the configuration of an optical device.

FIG. 3 is a flowchart illustrating the flow of a scattered light time-resolved waveform generation process.

FIG. 4 is a view illustrating an example of the data configuration of model data.

FIG. 5 is a view illustrating an example of the data configuration of scattered light time-resolved waveform data.

FIG. 6 is a flowchart illustrating the flow of a concentration measurement process.

FIG. 7 is a view illustrating an example of the configuration of an optical device according to a second embodiment.

FIG. 8 is a view illustrating an example of a functional configuration of a processing section according to the second embodiment.

FIG. 9 is a view illustrating an example of data stored in a storage section according to the second embodiment.

FIG. 10 is a view illustrating an example of the data configuration of scattered light time-resolved differential waveform data.

FIG. 11 is a flowchart illustrating the flow of a second concentration measurement process.

FIG. 12 is a flowchart illustrating the flow of a scattered light time-resolved differential waveform generation process.

### DESCRIPTION OF EXEMPLARY EMBODIMENTS

Several embodiments of the invention may implement a novel method that acquires a scattered light time-resolved waveform with high resolution. Several embodiments of the invention may make it possible to accurately measure the concentration of a component contained in an object based on a time-resolved waveform.

According to one embodiment of the invention, there is provided a component concentration measurement device comprising:

an irradiation section that applies measurement light to an object, the measurement light being pulsed light;

a condenser section that condenses emitted light from the object;

a detection section that detects light intensity;

a gate light guide section that guides gate light, and is configured so that an optical path length can be changed, the gate light being pulsed light that is synchronized with the measurement light;

an optical shutter section that allows light that has been condensed by the condenser section to pass through toward the detection section based on the gate light guided by the gate light guide section;

an optical path length control section that changes the optical path length of the gate light guide section; and

a calculation section that calculates a time-resolved waveform from a detection result of the detection section, and calculates a concentration of a component contained in the object.

According to another embodiment of the invention, there is provided a component concentration measurement method comprising:

guiding pulsed light that is synchronized with measurement light to an optical shutter section as gate light, the measurement light being pulsed light, and the optical shutter section allowing emitted light from an object when the measurement light has been applied to the object to pass through based on the gate light;

changing an optical path length of the gate light that is guided to the optical shutter section;

detecting intensity of light that has passed through the optical shutter section; and

calculating a time-resolved waveform from the intensity of the light detected while changing the optical path length, and calculating a concentration of a component contained in the object.

According to the above configuration, the measurement light (pulsed light) is applied to the object. Emitted light from the object when the measurement light has been applied to the object is condensed, and the intensity of the emitted light is detected. The light condensed by the condenser section is allowed to pass through toward the detection section based on the gate light (i.e., pulsed light that is synchronized with the measurement light). The gate light is guided by the gate light guide section that is configured so that the optical path length can be changed. After changing the optical path length of the gate light guide section, the time-resolved waveform is calculated from the light intensity detection result at the optical path length that has been changed, and the concentration of the component contained in the object is calculated.

The time-resolved waveform of the emitted light from the object can be acquired by guiding the gate light (i.e., pulsed light that is synchronized with the measurement light) while changing the optical path length, and allowing the light condensed by the condenser section to pass through toward the detection section. The time-resolved waveform of the emitted light can be acquired with high resolution by setting the pulse width of the gate light to a short time width (e.g., femtosecond). It is possible to accurately determine the concentration of the component contained in the object by utilizing the time-resolved waveform thus acquired.

In the component concentration measurement device,

the calculation section may include an optical absorption coefficient calculation section that calculates an optical absorption coefficient of the object using the time-resolved waveform and an optical path model of the pulsed light that propagates through the object, and the calculation section may calculate the concentration of the component contained in the object using the optical absorption coefficient calculated by the optical absorption coefficient calculation section.

According to the above configuration, the optical absorption coefficient of the object is calculated using the time-resolved waveform acquired as described above, and the optical path model of the pulsed light that propagates through the object. It is possible to accurately calculate the concentration of the component contained in the object by utilizing the optical absorption coefficient.

In the component concentration measurement device,

the calculation section may calculate the concentration of the component contained in the object using a difference between the time-resolved waveform and a reference time-resolved waveform, the reference time-resolved waveform being a time-resolved waveform measured when applying the measurement light to a reference material having known optical characteristics.

According to the above configuration, the concentration of the component contained in the object is calculated using the difference between the time-resolved waveform acquired as described above and the reference time-resolved waveform (i.e., a time-resolved waveform measured when applying the measurement light to the reference material having known optical characteristics). The reference material has known optical characteristics. Therefore, a small difference in optical characteristics between the object and the reference material can be determined by utilizing a reference material that provides a reference time-resolved waveform that is similar to the time-resolved waveform measured when applying the measurement light to the object. This makes it possible to highly accurately calculate the concentration of the component contained in the object.

In the component concentration measurement device,

the optical shutter section may be formed by providing a Kerr material between a pair of polarizers that are positioned so that transmission axes thereof are orthogonal to each other, and

the gate light guide section may guide the gate light to the Kerr material.

According to the above configuration, the optical shutter section is formed by providing the Kerr material between a pair of polarizers that are positioned so that the transmission axes thereof are orthogonal to each other, and the gate light is guided to the Kerr material. This makes it possible to implement the optical shutter using a simple configuration.

The component concentration measurement device may further comprise:

a light source that generates pulsed light; and

a splitter section that splits the pulsed light into the measurement light and the gate light.

It is possible to easily obtain the measurement light and the gate light that are synchronized with each other by splitting the pulsed light generated by the light source.

In the component concentration measurement device,

the calculation section may calculate at least a concentration of glucose contained in the object.

This makes it possible to accurately calculate at least the concentration of glucose contained in the object.

Embodiments of a component concentration measurement device that measures the concentration of a component contained in an object using an optical device are described below with reference to the drawings. Note that the embodiments to which the invention may be applied are not limited to the following embodiments.

### 1. First Embodiment

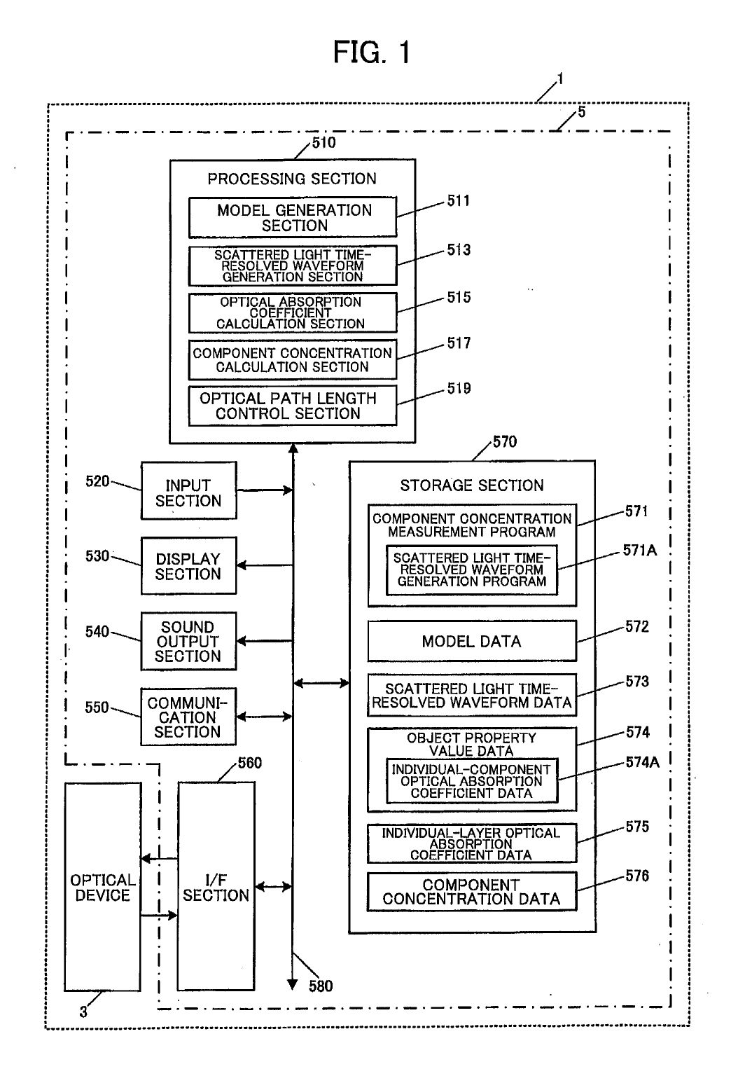

FIG. 1 is a block diagram illustrating an example of a functional configuration of a component concentration measurement device 1 according to a first embodiment of the invention. The component concentration measurement device 1 includes an optical device 3 and a calculation device 5 as the main elements. The component concentration measurement device 1 is incorporated in a measurement system such as a sugar content measurement device that measures the sugar content in fruit, or a blood glucose level measurement device that measures the human blood glucose level.

1-1. Configuration of Optical Device 3

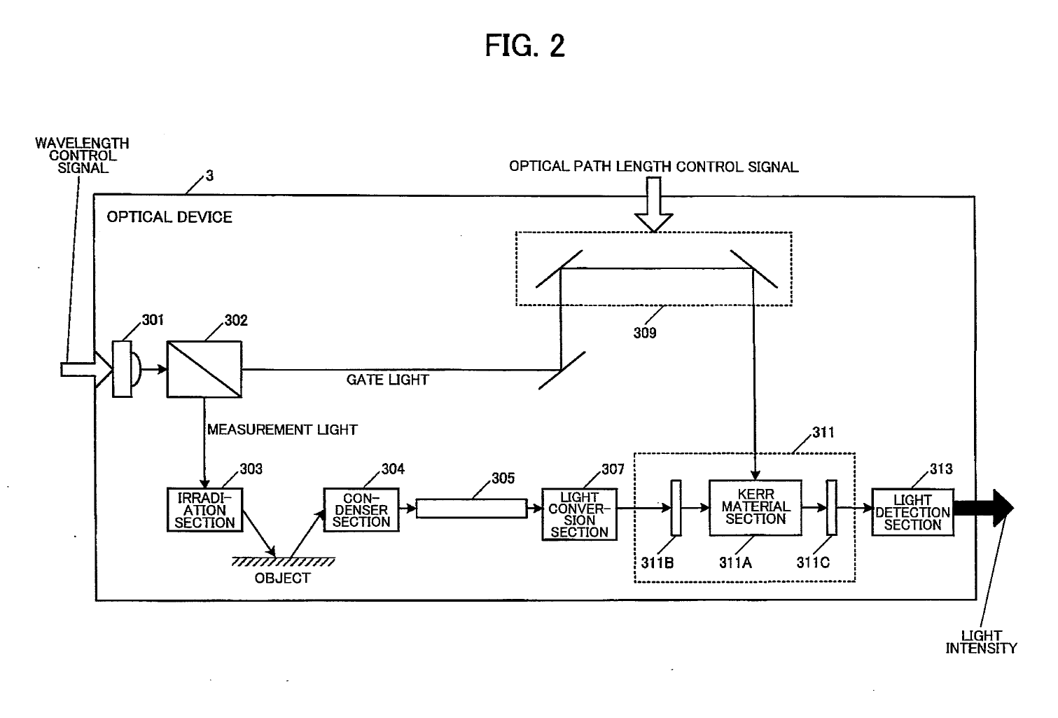

FIG. 2 is a view illustrating a schematic optical configuration of the optical device 3. The optical device 3 includes a light source section 301, a splitter section 302, an irradiation section 303, a condenser section 304, a relay section 305, a light conversion section 307, a gate light guide section 309, an optical shutter section 311, and a light detection section 313, for example.

The light source section 301 is a light source that generates and emits pulsed light. The light source section 301 includes a pulsed light generator such as a femtosecond laser. The light source section 301 generates pulsed light having a wavelength that corresponds to a wavelength control signal input from the calculation device 5.

The splitter section 302 is an optical splitter that splits the pulsed light emitted from the light source section 301. The splitter section 302 includes a half mirror, for example. The splitter section 302 splits the pulsed light into measurement light and gate light. The measurement light is applied to an object by the irradiation section 303. The gate light is guided to the gate light guide section 309. Therefore, the measurement light and the gate light are pulsed lights that are synchronized with each other.

The object is a component concentration measurement target substance or solution. In the first embodiment, the object is human skin. Human skin is roughly classified into an epidermis layer, a dermis layer, and a subcutaneous tissue layer. The first embodiment aims at measuring the concentration of glucose contained in the dermis layer.

The condenser section 304 condenses emitted light from the object when the measurement light has been applied to the object from the outside. More specifically, the condenser section 304 condenses backscattered light (hereinafter simply referred to as “scattered light”) that occurs when the measurement light has been applied to the object as the emitted light, and guides the scattered light to the relay section 305. The condenser section 304 may be referred to as a light-receiving section that receives the scattered light. The condenser section 304 includes a lens, for example.

The relay section 305 relays the scattered light condensed by the condenser section 304 to the light conversion section 307. The relay section 305 includes an optical fiber, for example.

The light conversion section 307 converts the emitted light relayed by the relay section 305 into parallel light. The light conversion section 307 includes a collimating lens, for example.

The gate light guide section 309 is a device that is configured so that the optical path length of the gate light obtained by the splitter section 302 can be changed, and forms a light guide path that guides the gate light to the optical shutter section 311. The gate light guide section 309 may be implemented by a mechanism that includes a variable path length cell or the like, or may be implemented by a mechanism that physically changes the optical path length of the gate light that enters the optical shutter section 311 by changing (sliding) the positions of two reflectors that guide the gate light to the optical shutter section 311 (see FIG. 2), for example.

The optical shutter section 311 allows the light that has been condensed by the condenser section 304 and relayed by the relay section 305 to pass through toward the light detection section 313 based on the light guided by the gate light guide section 309. The optical shutter section 311 includes a Kerr material section 311A, a first polarizer section 311B, and a second polarizer section 311C.

The Kerr material section 311A is formed of a crystalline or amorphous material that changes in refractive index due to an optical Kerr effect. The Kerr material section 311A includes an organic solvent (e.g., carbon disulfide), chalcogen glass, lead-containing glass, or the like. The first polarizer section 311B and the second polarizer section 311C (i.e., a pair of polarizer sections) are disposed on either side of the Kerr material section 311A.

The first polarizer section 311B and the second polarizer section 311C are polarizers that convert the incident light into linearly polarized light. The first polarizer section 311B and the second polarizer section 311C are positioned so that the transmission axes thereof are orthogonal to each other. Specifically, the optical shutter section 311 is formed by providing the Kerr material between a pair of polarizers that are positioned so that the transmission axes thereof are orthogonal to each other.

Since the transmission axes of the first polarizer section 311B and the second polarizer section 311C are orthogonal to each other, light that has entered the Kerr material section 311A cannot pass through the second polarizer section 311C in a normal state. However, the refractive index of the Kerr material section 311A changes only in the vibration direction of the gate light at a timing at which the gate light has entered the Kerr material section 311A, so that the Kerr material section 311A has birefringence. As a result, the polarization state of the scattered light is modulated for a time that corresponds to the pulse length of the pulsed light, so that the scattered light passes through the second polarizer section 311C. The gate light guide section 309 guides the gate light to the Kerr material section 311A.

Note that it is preferable that the gate light and the measurement light differ in polarization direction by 45°. If the polarization direction of the gate light is the same as the polarization direction of the measurement light, the polarization state of the scattered light is not modulated (i.e., a Kerr shutter function cannot be implemented).

The light detection section 313 detects the intensity of the scattered light that has passed through the optical shutter section 311. The light detection section 313 includes a light-receiving element and a photoelectric conversion element, for example. The intensity of the scattered light received by the light-receiving element is photoelectrically converted by the photoelectric conversion element, and output to the calculation device 5 as voltage value data.

1-2. Principle

The light that has been emitted from the light source section 301 and has entered the object (skin) propagates through the object while repeating a scattering process, and exits from the object. The light that has exited from the object passes through the relay section 305 and the like, and is received by the light detection section 313. It is considered that the light that has reached the light detection section 313 has selectively passed through a given area (each skin layer) of the object corresponding to the detection time. Specifically, it is considered that the propagation path of photons that have propagated through the object is characterized by the light scattering coefficient, and a change in light intensity along the optical path is characterized by the optical absorption coefficient.

In the first embodiment, the temporal characteristics of the backscattered light (i.e., emitted light from the object when applying the pulsed light to the object) are referred to as “scattered light time-resolved waveform”. The scattered light time-resolved waveform is characterized in that light that has passed through only a shallow area from the surface is detected earlier, and light that has reached a deep area from the surface is detected later. The intensity of light detected at a different detection time corresponds to a light component that has a different optical path distribution. Specifically, the intensity of light detected at one detection time includes absorption information within the optical path distribution that corresponds to the detection time. Therefore, the optical absorption coefficient distribution can be estimated using an inverse problem solution technique by measuring an optical path that corresponds to each detection time of the time-resolved waveform in advance.

In the first embodiment, the time-resolved waveform of the scattered light from the object is measured based on the above principle by actually applying the pulsed light to the object (skin). The optical absorption coefficient of each skin layer is calculated based on the measured time-resolved waveform, and the concentration of glucose contained in the skin dermis layer is calculated using the calculated optical absorption coefficient.

The measurement light that has entered the object travels along various paths due to the scattering characteristics of the object, exits from the object as reflected light (scattered light), and is condensed by the condenser section 304. In this case, photons have traveled along various paths. Specifically, since the light acquired as scattered light includes photons that differ in travel path, the light is expressed by the distribution waveform of the number of acquired photons relative to the time axis.

The number of acquired photons is synonymous with the intensity of acquired light. Therefore, the waveform of the light observed as described above corresponds to the waveform of a temporal change in intensity of the scattered light. In the first embodiment, this waveform is referred to as “scattered light time-resolved waveform”. The scattered light time-resolved waveform is calculated as described below by utilizing the ultrahigh-speed shutter implemented by the optical shutter section 311.

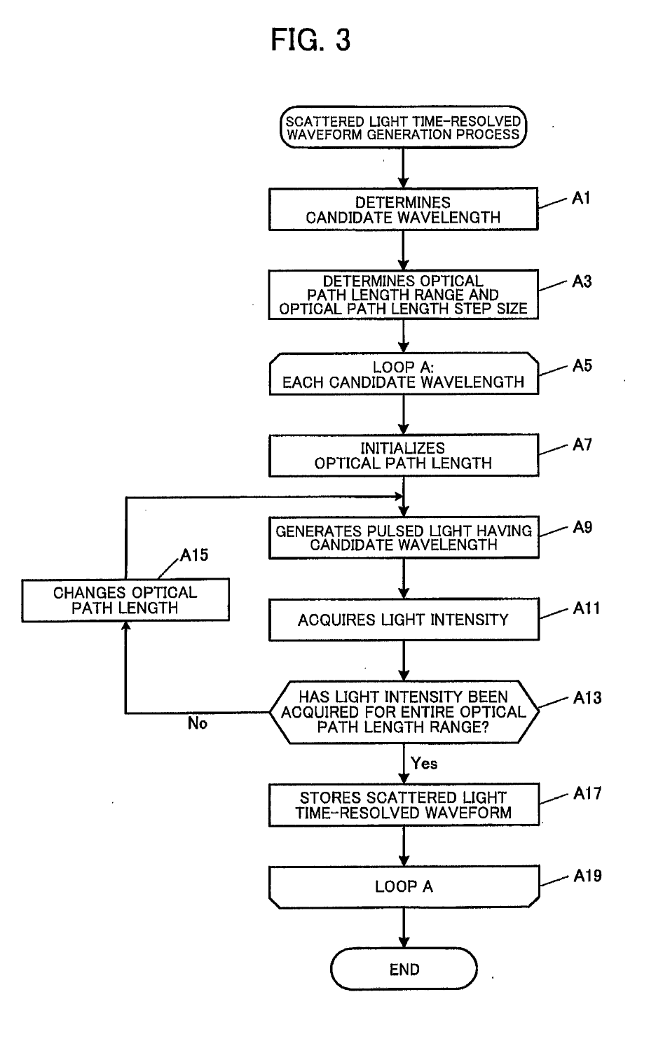

FIG. 3 is a flowchart illustrating the flow of a scattered light time-resolved waveform generation process that generates the scattered light time-resolved waveform.

In a step A1, a candidate wavelength of the pulsed light is determined. The candidate wavelength may be selected from arbitrary wavelengths. It is effective to select a wavelength that increases the orthogonality of the absorption spectrum of the main components of the object as the candidate wavelength. More specifically, it is preferable to select a wavelength that increases the orthogonality of the absorption spectrum of the main components (i.e., water, proteins, lipids, and glucose) of the skin dermis layer as the candidate wavelength.

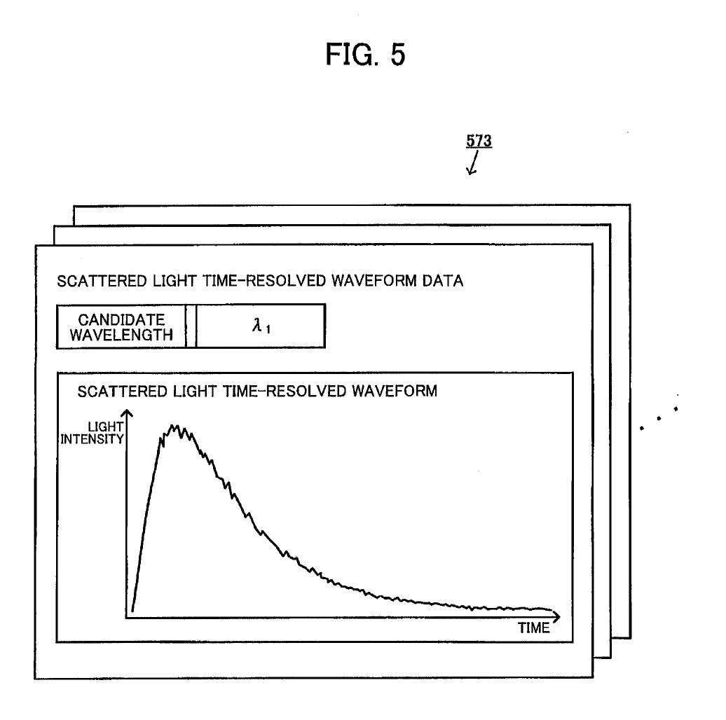

The optical path length range and the optical path length step size of the gate light are determined (step A3). More specifically, a range in which almost the entire shape of the scattered light time-resolved waveform is obtained is determined to be the optical path length range, and the optical path length step size is determined depending on the accuracy (resolution) of the scattered light time-resolved waveform. It is preferable to determine a range illustrated in FIG. 5 in which almost the entire shape of the scattered light time-resolved waveform is obtained to be the optical path length range.

A loop A process is performed on each candidate wavelength determined in the step A1 (steps A5 to A19). In the loop A process, the optical path length is initialized (step A7). More specifically, the gate light guide section 309 is controlled so that the optical path length of the gate light is equal to the initial value within the optical path length range determined in the step A3.

The light source section 301 is controlled so that the light source section 301 generates pulsed light having the candidate wavelength (step A9). The intensity of the scattered light detected by the light detection section 313 at a timing at which the optical shutter section 311 has allowed the scattered light from the object (skin) to pass through is acquired (step A11).

Whether or not the light intensity has been acquired for the entire optical path length range is determined (step A13). When it has been determined that the light intensity has not been acquired for the entire optical path length range (step A13: No), the gate light guide section 309 is controlled so that the optical path length of the gate light is changed by the optical path length step size determined in the step A3 (step A15). The step A9 is then performed again.

When it has been determined that the light intensity has been acquired for the entire optical path length range (step A13: Yes), the scattered light time-resolved waveform indicated by the light intensity that corresponds to each optical path length acquired in the step A11 is stored (step A17). The process is then performed on the next candidate wavelength. When the process in the steps A1 and A17 has been performed on each candidate wavelength, the loop A process ends (step A19). The scattered light time-resolved waveform generation process is thus completed.

When the scattered light time-resolved waveform has thus been generated, the light intensity at a different time is acquired based on the scattered light time-resolved waveform. The optical absorption coefficient of each skin layer is then calculated, and the concentration of glucose contained in the dermis layer is calculated using the calculated optical absorption coefficient. The details of the above process are described later using a flowchart.

1-3. Configuration of Calculation Device 5

The calculation device 5 is a control device that controls the optical device 3. The calculation device 5 also functions as a calculation device that calculates and measures the concentration of glucose contained in the dermis layer based on the light intensity acquired from the optical device 3.

As illustrated in FIG. 1, the calculation device 5 is a computer system that includes a processing section 510, an input section 520, a display section 530, a sound output section 540, a communication section 550, an interface (I/F) section 560, and a storage section 570, the processing section 510, the input section 520, the display section 530, the sound output section 540, the communication section 550, the I/F section 560, and the storage section 570 being connected via a bus 580.

The processing section 510 is a control device/calculation device that controls each section of the calculation device 5 and the optical device 3 according to a program (e.g., a system program) stored in the storage section 570. The processing section 510 includes processors such as a central processing unit (CPU) and a digital signal processor (DSP).

The processing section 510 includes a model generation section 511, a scattered light time-resolved waveform generation section 513, an optical absorption coefficient calculation section 515, a component concentration calculation section 517, and an optical path length control section 519 as the main functional sections. Note that these functional sections are merely examples, and the processing section 510 need not necessarily include all of these functional sections.

The model generation section 511 performs a simulation that utilizes a Monte Carlo method (Monte Carlo simulation) to calculate the propagation optical path length distribution “Lₘ(t)” of each skin layer when the number of incident photons is “Nᵢₙ”. The model generation section 511 also performs the Monte Carlo simulation to calculate the zero-absorption scattered light intensity temporal characteristics “N(t)” when the optical absorption coefficient is zero and the number of incident photons is “Nᵢₙ”.

The scattered light time-resolved waveform generation section 513 performs the scattered light time-resolved waveform generation process (see FIG. 3) according to a scattered light time-resolved waveform generation program 571A stored in the storage section 570 to calculate the scattered light time-resolved waveform “R(t)”.

The optical absorption coefficient calculation section 515 calculates the optical absorption coefficient of each skin layer. The component concentration calculation section 517 calculates the concentration of each component contained in the dermis layer.

The optical path length control section 519 outputs the optical path length control signal to the gate light guide section 309 included in the optical device 3 to change (control) the optical path length of the gate light guide section 309.

The input section 520 is an input device that includes a keyboard, a button switch, and the like. The input section 520 outputs a signal to the processing section 510 when a key or a button has been pressed. The user inputs data or instructions (e.g., component concentration measurement start instruction) by operating the input section 520.

The display section 530 is a display that displays an image and the like based on a display signal output from the processing section 510. The display section 530 includes a liquid crystal display (LCD) or the like. The display section 530 displays information about the component concentration calculated by the component concentration calculation section 517, for example.

The sound output section 540 is a sound output device that outputs sound output based on a sound output signal output from the processing section 510. The sound output section 540 includes a speaker or the like. The sound output section 540 outputs component concentration measurement guidance sound, alarm sound, and the like.

The communication section 550 is a communication device that allows the calculation device 5 to communicate with an external information processing device via cable communication or wireless communication. The communication section 550 includes a cable communication module that performs cable communication, a wireless communication module that performs wireless LAN communication, spread spectrum communication, and the like, for example.

The I/F section 560 is an input/output interface for exchanging data (e.g., inputting light intensity data or outputting a control signal) between the optical device 3 and the calculation device 5.

The storage section 570 includes a memory (e.g., read-only memory (ROM), flash ROM, and random access memory (RAM)). The storage section 570 stores a system program for the calculation device 5, programs that implement various functions (e.g., scattered light time-resolved waveform generation function and component concentration measurement function), data, and the like. The storage section 570 includes a work area that temporarily stores processing target data, processing results, and the like.

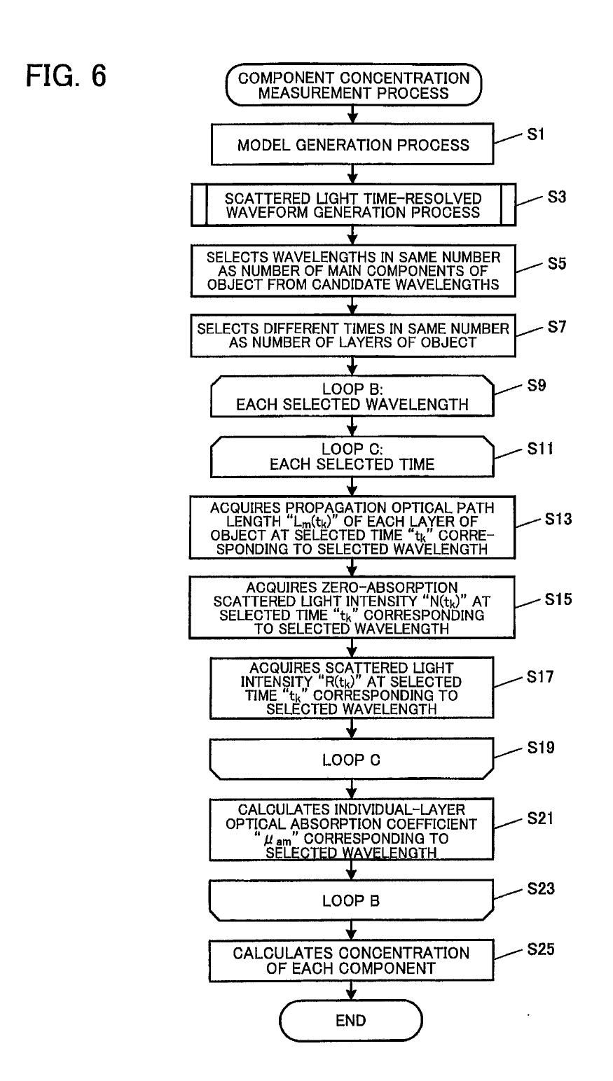

The storage section 570 stores a component concentration measurement program 571 that is read by the processing section 510, and implements a component concentration measurement process (see FIG. 6). The component concentration measurement program 571 includes a scattered light time-resolved waveform generation program 571A that implements the scattered light time-resolved waveform generation process (see FIG. 3) as a subroutine.

The storage section 570 stores model data 572, scattered light time-resolved waveform data 573, object property value data 574, individual-layer optical absorption coefficient data 575, and component concentration data 576, for example.

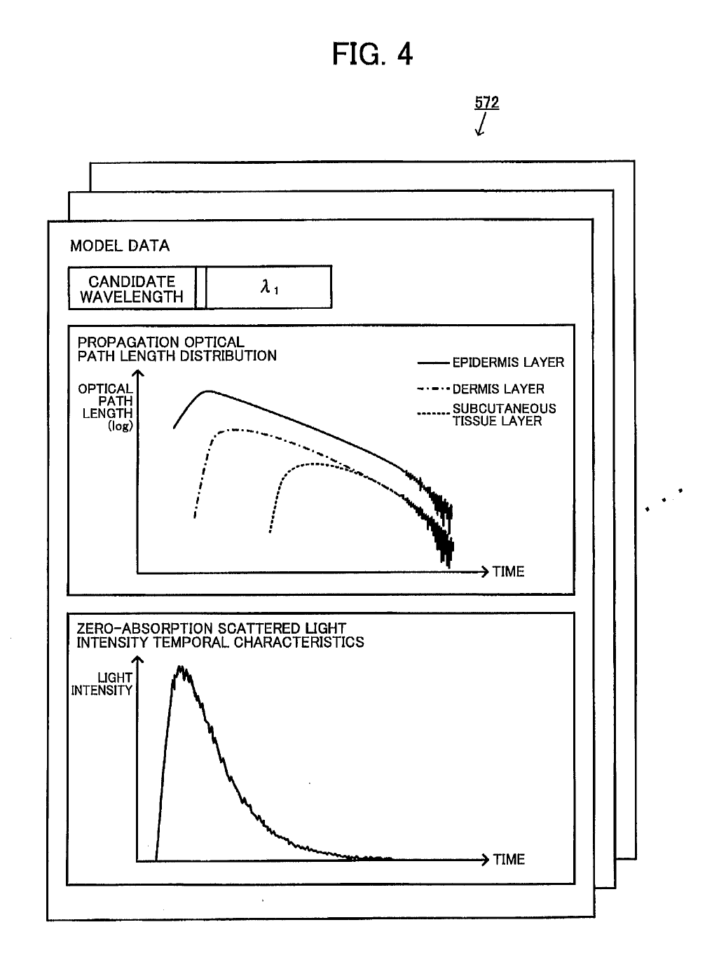

The model data 572 indicates a model generated by the model generation section 511 via the Monte Carlo simulation or the like. FIG. 4 illustrates a data configuration example of the model data 572. The model data 572 includes the candidate wavelength, the propagation optical path length distribution, and the zero-absorption scattered light intensity temporal characteristics.

The propagation optical path length distribution is a model of the propagation optical path length of photons of the pulsed light when the number of incident photons is “Nᵢₙ” (calculated by the Monte Carlo simulation). More specifically, a skin model having an optical absorption coefficient of zero is generated, and the distance and the direction when a photon travels to the next point in each layer of the skin model are repeatedly calculated on a unit time basis using random numbers. This simulation is performed on a number of photons to classify the moving path of each photon that has reached the light detection section 313 on a layer basis. The average moving path length of the photons that have reached the light detection section 313 within the unit time is calculated on a layer basis to obtain the individual-layer propagation optical path length distribution “Lₘ(t)” (see FIG. 4), for example.

The zero-absorption scattered light intensity temporal characteristics indicate a model of the scattered light intensity when the optical absorption coefficient is zero and the number of incident photons is “Nᵢₙ” (calculated by the Monte Carlo simulation). More specifically, the number of photons (=scattered light intensity) detected by the light detection section 313 when applying the pulsed light to the skin model having an optical absorption coefficient of zero is calculated on a unit time basis to obtain the zero-absorption scattered light intensity temporal characteristics “N(t)” (see FIG. 4). The scattered light intensity (vertical axis) is synonymous with the number of photons detected by the light detection section 313.

The scattered light time-resolved waveform data 573 indicates the scattered light time-resolved waveform generated by the scattered light time-resolved waveform generation section 513. FIG. 5 illustrates a data configuration example of the scattered light time-resolved waveform data 573. The scattered light time-resolved waveform data 573 includes the candidate wavelength and the scattered light time-resolved waveform. The scattered light time-resolved waveform is the time-resolved waveform of the scattered light from the object (scattered light intensity temporal characteristics) that is measured by the optical device 3 by utilizing the optical shutter of the optical shutter section 311.

The object property value data 574 includes the property values of the components contained in the skin dermis layer. For example, the object property value data 574 includes individual-component optical absorption coefficient data 574A that indicates the optical absorption coefficients of water, proteins, lipids, and glucose. The object property value data 574 is data (known values) that is measured and stored in advance as the property values of the object.

The individual-layer optical absorption coefficient data 575 includes the optical absorption coefficients of the epidermis layer, the dermis layer, and the subcutaneous tissue layer that are calculated by solving given simultaneous equations (described later).

The component concentration data 576 includes measurement data about the concentrations of water, proteins, lipids, and glucose contained in the dermis layer (calculated by solving given simultaneous equations (described later)).

1-4. Process Flow

FIG. 6 is a flowchart illustrating the flow of the component concentration measurement process performed by the component concentration measurement device 1 by causing the processing section 510 to read and execute the component concentration measurement program 571 stored in the storage section 570.

In a step S1, the model generation section 511 performs a model generation process. More specifically, the model generation section 511 generates the propagation optical path length distribution “Lₘ(t)” and the zero-absorption scattered light intensity temporal characteristics “N(t)” by performing the Monte Carlo simulation, for example. These models are stored in the storage section 570 as the model data 572.

The scattered light time-resolved waveform generation section 513 then performs the scattered light time-resolved waveform generation process (see FIG. 3) according to the scattered light time-resolved waveform generation program 571A stored in the storage section 570 (step S3).

The processing section 510 selects wavelengths in the same number as the number of the main components of the object from a plurality of candidate wavelengths (step S5). The dermis layer contains water, proteins, lipids, and glucose as the main components. Therefore, the processing section 510 selects four wavelengths λ₁, λ₂, λ₃, and λ₄ from a plurality of candidate wavelengths in the step S5.

The processing section 510 then selects different times in the same number as the number of layers of the object (step S7). Since the skin includes the epidermis layer, the dermis layer, and the subcutaneous tissue layer, the processing section 510 selects three different times tₖ (=t₁, t₂, and t₃) in the step S7.

The processing section 510 then performs a loop B process on each wavelength selected in the step S5 (steps S9 to S23). In the loop B process, the processing section 510 performs a loop C process on each time selected in the step S7 (steps S11 to S19).

In the loop C process, the processing section 510 acquires the propagation optical path length “Lₘ(tₖ)” of each layer of the object at the selected time “tₖ” from the propagation optical path length distribution “Lₘ(t)” included in the model data 572 corresponding to the selected wavelength (step S13). The processing section 510 also acquires the zero-absorption scattered light intensity “N(tₖ)” at the selected time “tₖ” from the zero-absorption scattered light intensity temporal characteristics “N(t)” included in the model data 572 corresponding to the selected wavelength (step S15).

The processing section 510 acquires the scattered light intensity “R(tₖ)” at the selected time “tₖ” from the scattered light time-resolved waveform data 573 corresponding to the selected wavelength (step S17). The processing section 510 then performs the loop C process on the next selected time.

When the processing section 510 has performed the process in the steps S13 and S17 on each selected time, the processing section 510 terminates the loop C process (step S19). The optical absorption coefficient calculation section 515 then calculates the individual-layer optical absorption coefficient “μₐₘ” corresponding to the selected wavelength (step S21).

More specifically, the optical absorption coefficient calculation section 515 solves simultaneous equations for the three selected times (see the following expressions (1) and (2)) to calculate the optical absorption coefficient “μₐ₁” of the epidermis layer, the optical absorption coefficient “μₐ₂” of the dermis layer, and the optical absorption coefficient “μₐ₃” of the subcutaneous tissue layer. The optical absorption coefficient calculation section 515 stores the calculated optical absorption coefficients in the storage section 570 as the individual-layer optical absorption coefficient data 575.

$$\begin{matrix}N ( t ) ln ( \frac{{N}^{′} ( t )}{{R}^{′} ( t )} ) = {\sum }_{m = 1}^{M} {μ}_{am} {L}_{m} ( t ) \\ where , {N}^{′} ( t ) = \frac{N ( t )}{{N}_{in}} , {R}^{′} ( t ) = \frac{R ( t )}{{I}_{in}} & ( 1 ) \\ \{ \begin{matrix}N ( {t}_{1} ) ln ( \frac{{N}^{′} ( {t}_{1} )}{{R}^{′} ( {t}_{1} )} ) = {μ}_{a 1} {L}_{1} ( {t}_{1} ) + {μ}_{a 2} {L}_{2} ( {t}_{1} ) + {μ}_{a 3} {L}_{3} ( {t}_{1} ) \\ N ( {t}_{2} ) ln ( \frac{{N}^{′} ( {t}_{2} )}{{R}^{′} ( {t}_{2} )} ) = {μ}_{a 1} {L}_{1} ( {t}_{2} ) + {μ}_{a 2} {L}_{2} ( {t}_{2} ) + {μ}_{a 3} {L}_{3} ( {t}_{2} ) \\ N ( {t}_{3} ) ln ( \frac{{N}^{′} ( {t}_{3} )}{{R}^{′} ( {t}_{3} )} ) = {μ}_{a 1} {L}_{1} ( {t}_{3} ) + {μ}_{a 2} {L}_{2} ( {t}_{3} ) + {μ}_{a 3} {L}_{3} ( {t}_{3} )\end{matrix} & ( 2 )\end{matrix}$$

where, “μₐₘ” is the individual-layer optical absorption coefficient, and the suffix “m” is the number of the skin layer. The number of the epidermis layer is indicated by “1”, the number of the dermis layer is indicated by “2”, and the number of the subcutaneous tissue layer is indicated by “3”. “M” is the number of skin layers (i.e., “M=3”). Therefore, “μₐ₁” is the optical absorption coefficient of the epidermis layer, “μₐ₂” is the optical absorption coefficient of the dermis layer, and “μₐ₃” is the optical absorption coefficient of the subcutaneous tissue layer.

“Lₘ(t)” is the propagation optical path length distribution in the mth skin layer. For example, “Lₘ(t₁)” is the total photon propagation length in the mth layer detected at the time “t₁”. “Nᵢₙ” is the total number of incident photons of the pulsed light (known value). “Iᵢₙ” is the pulsed light intensity (incident light intensity) (known value).

The expression (1) is derived based on the fact that the light intensity “R(t)” detected at the time “t” can be approximately written by the following expression (3).

$$R ( t ) = \frac{{I}_{in}}{{N}_{in}} exp ( - {\sum }_{m = 1}^{M} {μ}_{am} {L}_{m}^{′} ( t ) ) N ( t ) \qquad ( 3 )$$

where, “L′ₘ(t)” is the average photon propagation length in the mth skin layer (i.e., a value obtained by dividing the total propagation length “Lₘ(t)” by “N′(t)” (see the following expression (4)).

$${L}_{m}^{′} ( t ) = \frac{{L}_{m} ( t )}{{N}^{′} ( t )} \qquad ( 4 )$$

Transforming the expression (3) using the expression (4) yields the expression (1).

When the processing section 510 has performed the process in the steps S11 and S21 on each selected wavelength, the processing section 510 terminates the loop B process (step S23).

The component concentration calculation section 517 then calculates the concentration of each component contained in the object (step S25). When the total number of components is “N”, the volume fraction “cᵥᵢ” of each component is calculated by the following expression (5).

$${μ}_{a 2} = {\sum }_{i}^{N} {μ}_{ai} {c}_{vi} \qquad ( 5 )$$

The dermis layer contains water, proteins, lipids, and glucose as the main components (i.e., N=4). In this case, the expression (5) can be rewritten as shown by the following expression (6). The volume fractions of water, proteins, lipids, and glucose are calculated using the expression (6).

$$\{ \begin{matrix}{μ}_{a 2} ( {λ}_{1} ) = {μ}_{aw} ( {λ}_{1} ) {c}_{vw} + {μ}_{ap} ( {λ}_{1} ) {c}_{vp} + {μ}_{al} ( {λ}_{1} ) {c}_{vl} + {μ}_{ag} ( {λ}_{1} ) {c}_{vg} \\ {μ}_{a 2} ( {λ}_{2} ) = {μ}_{aw} ( {λ}_{2} ) {c}_{vw} + {μ}_{ap} ( {λ}_{2} ) {c}_{vp} + {μ}_{al} ( {λ}_{2} ) {c}_{vl} + {μ}_{ag} ( {λ}_{2} ) {c}_{vg} \\ {μ}_{a 2} ( {λ}_{3} ) = {μ}_{aw} ( {λ}_{3} ) {c}_{vw} + {μ}_{ap} ( {λ}_{3} ) {c}_{vp} + {μ}_{al} ( {λ}_{3} ) {c}_{vl} + {μ}_{ag} ( {λ}_{3} ) {c}_{vg} \\ {μ}_{a 2} ( {λ}_{4} ) = {μ}_{aw} ( {λ}_{4} ) {c}_{vw} + {μ}_{ap} ( {λ}_{4} ) {c}_{vp} + {μ}_{al} ( {λ}_{4} ) {c}_{vl} + {μ}_{ag} ( {λ}_{4} ) {c}_{vg}\end{matrix} \qquad ( 6 )$$

where, “μₐᵢ” is the optical absorption coefficient of each component, and the suffix “i” is the sign of each component. Water is indicated by “w”, proteins are indicated by “p”, lipids are indicated by “p”, and glucose is indicated by “g”. Specifically, “μ_{aw}” and “μₐₚ”, “μₐ₁”, and “μ_{ag}” respectively indicate the optical absorption coefficient of water, the optical absorption coefficient of proteins, the optical absorption coefficient of lipids, and the optical absorption coefficient of glucose.

“μ_{aw}(λ₁) to μ_{aw}(λ₄)”, “μₐₚ(λ₁) to μₐₚ(λ₄)”, “μₐ₁(λ₁) to μₐ₁(λ₄)”, and “μ_{ag}(λ₁) to μ_{ag}(λ₄)” on the right side of the expression (6) respectively indicate the optical absorption coefficient of water, the optical absorption coefficient of proteins, the optical absorption coefficient of lipids, and the optical absorption coefficient of glucose determined depending on the wavelength. These data (known values) are stored in advance as the object property value data 574 (i.e., individual-component optical absorption coefficient data 574A).

“cᵥᵢ” is the volume fraction of each component, and the suffix “i” is the sign of each component (see above). Specifically, “c_{vw}” and “cᵥₚ”, “cᵥₗ”, and “c_{vg}” respectively indicate the volume fraction of water, the volume fraction of proteins, the volume fraction of lipids, and the volume fraction of glucose. Each volume fraction is unknown.

The left side of the expression (6) indicates the optical absorption coefficients “μₐ₂(λ₁)”, “μₐ₂(λ₂)”, “μₐ₂(λ₃)”, and “μₐ₂(λ₄)” of the dermis layer (i=2) calculated in the step S21 corresponding to the four selected wavelengths. The optical absorption coefficients “μₐ₂(λ₁)”, “μₐ₂(λ₂)”, “μₐ₂(λ₃)”, and “μₐ₂(λ₄)” have been calculated in the step S21 by solving the above simultaneous equations (see the expression (2)).

“μ_{aw}(λ₁) to μ_{aw}(λ₄)”, “μₐₚ(λ₁) to μₐₚ(λ₄)”, “μₐ₁(λ₁) to μₐ₁(λ₄)”, and “μ_{ag}(λ₁) to μ_{ag}(λ₄)” on the right side of the expression (6) are known values. Therefore, the volume fractions “c_{vw}” and “cᵥₚ”, “cᵥₗ”, and “c_{vg}” of the respective components can be calculated by solving the simultaneous equations corresponding to the selected wavelengths λ₁ to λ₄.

When the volume fractions “c_{vw}” and “cᵥₚ”, “cᵥ₁”, and “c_{vg}” of the respective components have been calculated, the volume fraction is converted into weight volume concentration or the like to obtain the concentration of each component. The volume fraction may be converted into weight volume concentration or the like by a method known in the art. Therefore, detailed description thereof is omitted.

1-5. Advantageous Effects

According to the first embodiment, the light emitted from the light source section 301 is split into the measurement light and the gate light by the splitter section 302. The measurement light is applied to the object by the irradiation section 303. The emitted light from the object is condensed by the condenser section 304, and relayed to the light conversion section 307 by the relay section 305. The gate light obtained by the splitter section 302 is guided to the optical shutter section 311. In this case, the gate light is changed in optical path length by the gate light guide section 309, and guided to the Kerr material section 311A. As a result, the optical shutter operates at a different timing, so that the intensity of the emitted light at a different optical path length (i.e., different timing) is obtained. This is equivalent to acquiring emitted light that differs in scattering path inside the object. This makes it possible to accurately acquire the time-resolved waveform from the intensity of the emitted light.

Since the light source section 301 includes a femtosecond laser or the like, it is possible to obtain an accurate time-resolved waveform with an extremely high temporal resolution (e.g., femtosecond). It is possible to accurately determine the concentration of each component contained in the object by utilizing the time-resolved waveform thus acquired.

According to the first embodiment, the optical absorption coefficient of each layer of human skin is calculated using the scattered light time-resolved waveform obtained by the actual measurement, the modeled propagation optical path length distribution of the pulsed light that propagates through the object, and the modeled zero-absorption scattered light intensity temporal characteristics. It is possible to accurately calculate the concentration of each component contained in the object by utilizing the optical absorption coefficient.

The optical system according to the first embodiment is configured so that the pulsed light generated by the light source section 301 is split into the measurement light and the gate light by the splitter section 302. This makes it possible to easily generate the measurement light and the gate light (i.e., pulsed lights that are synchronized with each other) from the pulsed light generated by the light source section 301.

1-6. Modifications

1-6-1. Calculation of Optical Absorption Coefficient

The first embodiment has been described above taking an example in which the optical absorption coefficient of each skin layer is calculated by the expression (2). Note that the optical absorption coefficient of each skin layer may be calculated by the following integral expression (7) developed from the expression (1).

$$\{ \begin{matrix}{\int }_{τ1}^{τ2} ln [ \frac{{N}^{′} ( t )}{{R}^{′} ( t )} ] {L}_{1}^{′} ( t ) d t = {\sum }_{m = 1}^{3} {μ}_{am} {\int }_{τ1}^{τ2} {L}_{1}^{′} ( t ) {L}_{m}^{′} ( t ) d t \\ {\int }_{τ1}^{τ2} ln [ \frac{{N}^{′} ( t )}{{R}^{′} ( t )} ] {L}_{2}^{′} ( t ) d t = {\sum }_{m = 1}^{3} {μ}_{am} {\int }_{τ1}^{τ2} {L}_{2}^{′} ( t ) {L}_{m}^{′} ( t ) d t \\ {\int }_{τ1}^{τ2} ln [ \frac{{N}^{′} ( t )}{{R}^{′} ( t )} ] {L}_{3}^{′} ( t ) d t = {\sum }_{m = 1}^{3} {μ}_{am} {\int }_{τ1}^{τ2} {L}_{3}^{′} ( t ) {L}_{m}^{′} ( t ) d t\end{matrix} \qquad ( 7 )$$

1-6-2. Calculation of Concentration

The first embodiment has been described above taking an example in which the concentration of each component contained in the skin dermis layer is calculated by the expressions (5) and (6) based on the relationship between the optical absorption coefficient and the volume fraction. Note that the concentration of each component contained in the skin dermis layer is calculated by the following expressions (8) and (9) based on the relationship between the molar extinction coefficient and the molar concentration.

$$\begin{matrix}{μ}_{a 2} = {\sum }_{i}^{N} {ɛ}_{i} {c}_{i} & ( 8 ) \\ \{ \begin{matrix}{μ}_{a 2} ( {λ}_{1} ) = {ɛ}_{w} ( {λ}_{1} ) {c}_{w} + {ɛ}_{p} ( {λ}_{1} ) {c}_{p} + {ɛ}_{l} ( {λ}_{1} ) {c}_{l} + {ɛ}_{g} ( {λ}_{1} ) {c}_{g} \\ {μ}_{a 2} ( {λ}_{2} ) = {ɛ}_{w} ( {λ}_{2} ) {c}_{w} + {ɛ}_{p} ( {λ}_{2} ) {c}_{p} + {ɛ}_{l} ( {λ}_{2} ) {c}_{l} + {ɛ}_{g} ( {λ}_{2} ) {c}_{g} \\ {μ}_{a 2} ( {λ}_{3} ) = {ɛ}_{w} ( {λ}_{3} ) {c}_{w} + {ɛ}_{p} ( {λ}_{3} ) {c}_{p} + {ɛ}_{l} ( {λ}_{3} ) {c}_{l} + {ɛ}_{g} ( {λ}_{3} ) {c}_{g} \\ {μ}_{a 2} ( {λ}_{4} ) = {ɛ}_{w} ( {λ}_{4} ) {c}_{w} + {ɛ}_{p} ( {λ}_{4} ) {c}_{p} + {ɛ}_{l} ( {λ}_{4} ) {c}_{l} + {ɛ}_{g} ( {λ}_{4} ) {c}_{g}\end{matrix} & ( 9 )\end{matrix}$$

Alternatively, the concentration of each component contained in the skin dermis layer may be calculated based on the expression (7) described in page 12 of JP-A-2010-237139, for example.

### 2. Second Embodiment

The embodiments to which the invention may be applied are not limited to the first embodiment. A second embodiment of the invention is described below. Note that the same elements and the same steps as those mentioned above in connection with the first embodiment are indicated by the same signs, and description thereof is omitted.

2-1. Configuration of Optical Device

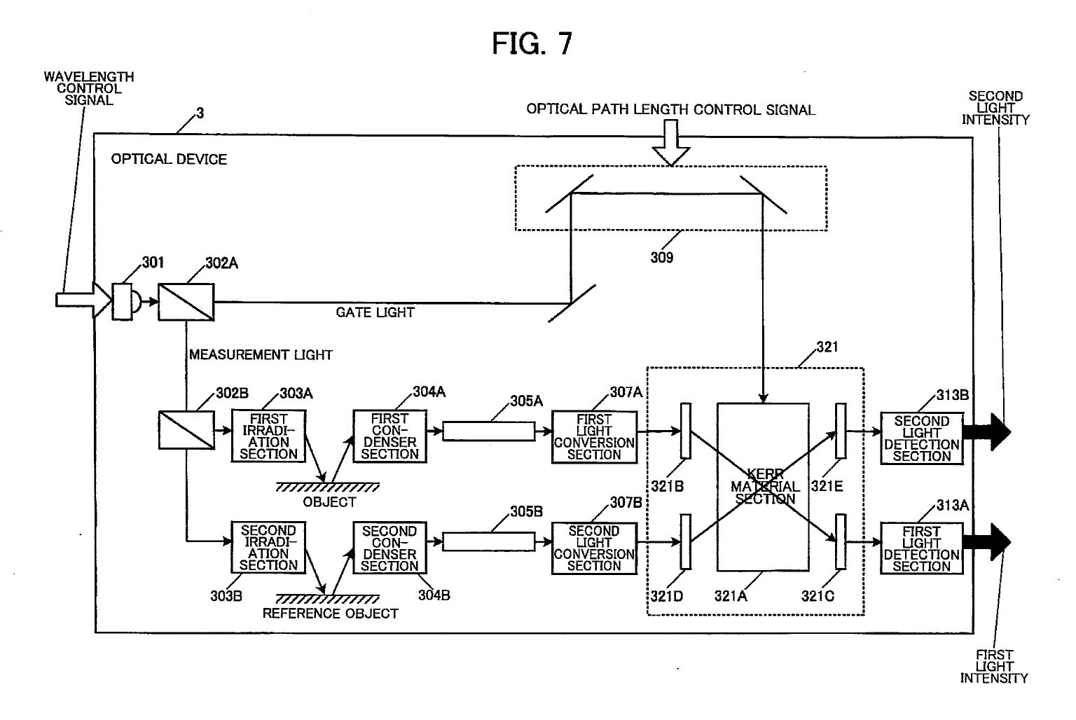

FIG. 7 is a view illustrating an example of the configuration of an optical device 3 according to the second embodiment. The optical device 3 includes a light source section 301, a first splitter section 302A, a second splitter section 302B, a first irradiation section 303A, a second irradiation section 303B, a first condenser section 304A, a second condenser section 304B, a first relay section 305A, a second relay section 305B, a first light conversion section 307A, a second light conversion section 307B, a gate light guide section 309, a second optical shutter section 321, a first light detection section 313A, and a second light detection section 313B, for example.

The first splitter section 302A splits pulsed light emitted from the light source section 301 into measurement light and gate light. The measurement light is then split by the second splitter section 302B, and respectively enters the first irradiation section 303A and the second irradiation section 303B. The first irradiation section 303A applies the received light to the object, and the second irradiation section 303B applies the received light to a reference object.

The reference object used in the second embodiment is a reference material that has optical absorption characteristics and light scattering characteristics similar to those of the object, and has known optical characteristics. For example, when the object is a human being, (1) colored frosted glass, (2) a mixture of water, black ink, and an intravenous fat emulsion, or the like is preferably used as the reference object (reference material). A colored reference object is used because a transparent material allows light to pass through. The intravenous fat emulsion is used to artificially produce fats contained in the skin dermis layer and the like. Note that soybean oil may be used instead of the intravenous fat emulsion.

A substance or a solution having characteristics similar to those of the object is used as the reference object so that the ratio of the light intensity when applying the pulsed light to the object and sampling part of the applied light using the optical shutter (hereinafter referred to as “first light intensity”) to the light intensity when applying the pulsed light to the reference object and sampling part of the applied light using the optical shutter (hereinafter referred to as “second light intensity”) is close to “1” (i.e., so that the difference between the first light intensity and the second light intensity approaches zero).

The second optical shutter section 321 includes a Kerr material section 321A, and two pairs of polarizers that are disposed at symmetrical positions with respect to the Kerr material section 321A. More specifically, the second optical shutter section 321 includes a first pair of polarizer sections formed by a first polarizer section 321B and a second polarizer section 321C, and a second pair of polarizer sections formed by a third polarizer section 321D and a fourth polarizer section 321E.

First scattered light that has entered the Kerr material section 321A cannot pass through the second polarizer section 321C in a normal state. Likewise, second scattered light that has entered the Kerr material section 321A cannot pass through the fourth polarizer section 321E in a normal state. However, since the Kerr material section 321A has birefringence at a timing at which the gate light has entered the Kerr material section 321A, the first scattered light and the second scattered light pass through the optical shutter section 321 in the same manner as in the first embodiment. Therefore, light is detected by the first light detection section 313A and the second light detection section 313B.

2-2. Configuration of Calculation Device

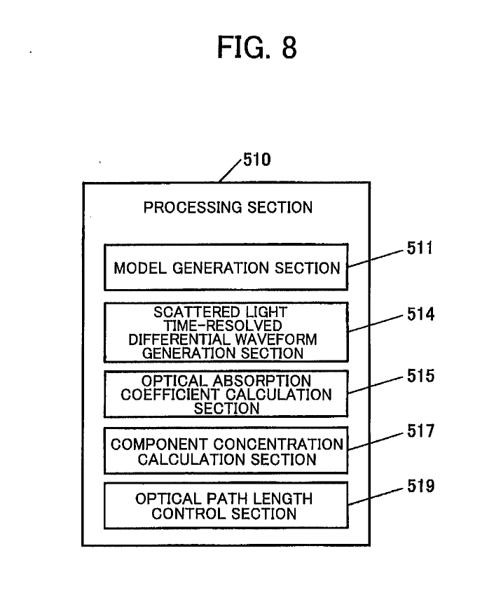

FIG. 8 is a view illustrating an example of a functional configuration of a processing section 510 included in a calculation device 5 according to the second embodiment. The processing section 510 includes a model generation section 511, a scattered light time-resolved differential waveform generation section 514, an optical absorption coefficient calculation section 515, a component concentration calculation section 517, and an optical path length control section 519 as functional sections.

The scattered light time-resolved differential waveform generation section 514 generates a scattered light time-resolved differential waveform based on the ratio of the first light intensity detected by the first light detection section 313A to the second light intensity detected by the second light detection section 313B (hereinafter referred to as “light intensity ratio”). The scattered light time-resolved differential waveform is a waveform that corresponds to the difference between the time-resolved waveform measured when applying the measurement light to the object and a reference time-resolved waveform measured when applying the measurement light to the reference material.

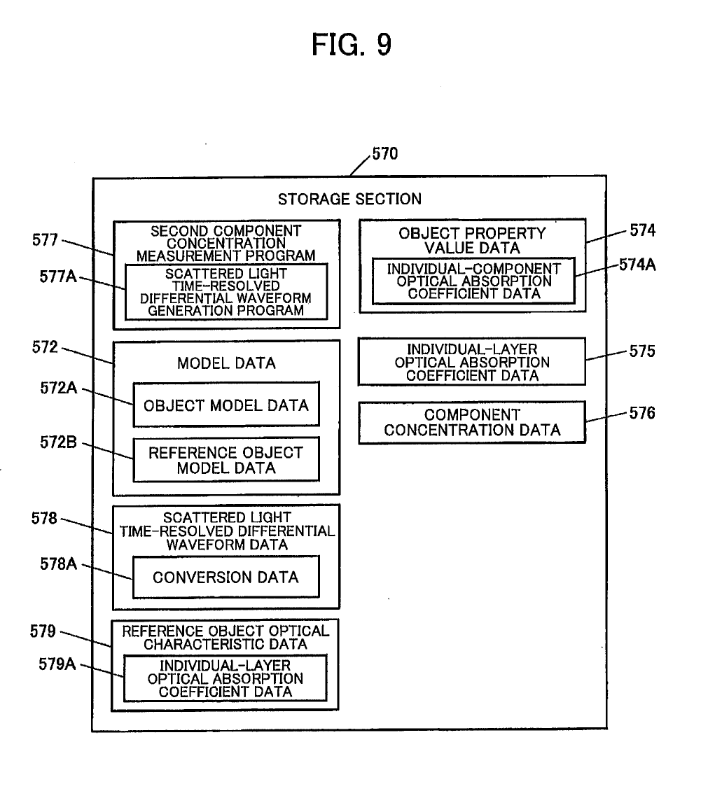

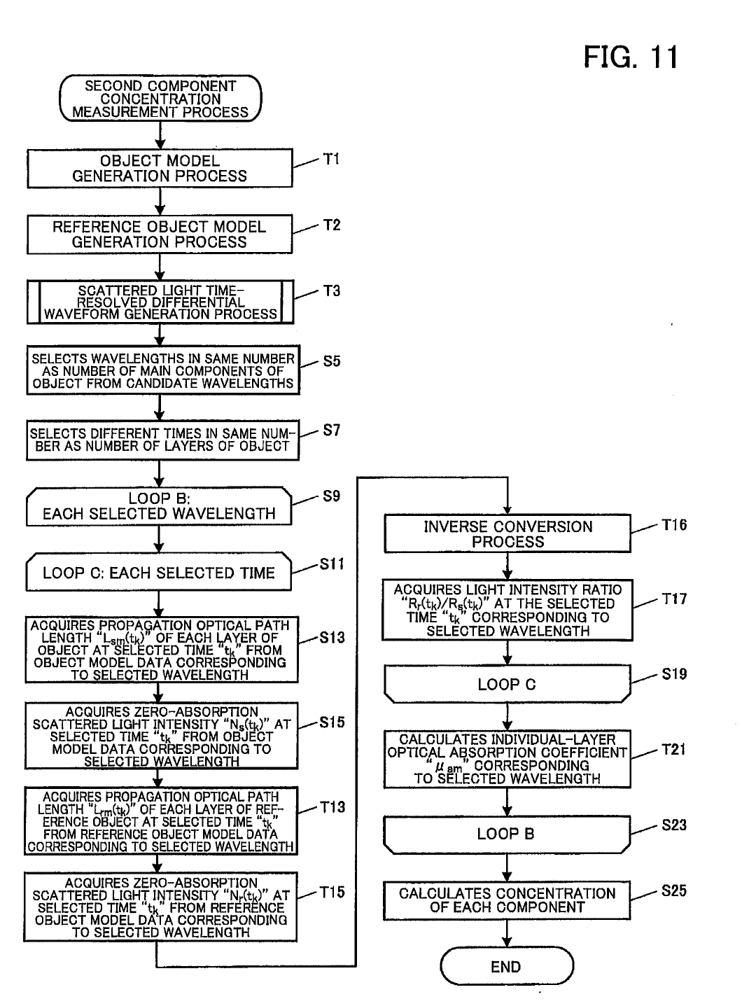

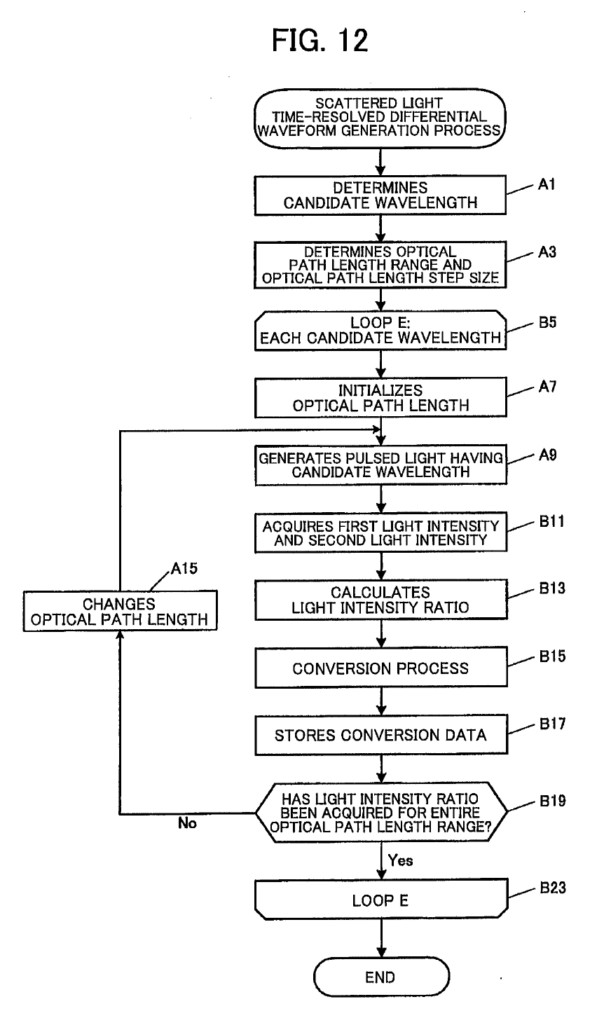

FIG. 9 is a view illustrating an example of the configuration of data stored in a storage section 570 included in the calculation device 5 according to the second embodiment. The storage section 570 stores a second component concentration measurement program 577 that implements a second component concentration measurement process (see FIG. 11). The second component concentration measurement program 577 includes a scattered light time-resolved differential waveform generation program 577A that implements a scattered light time-resolved differential waveform generation process (see FIG. 12) as a subroutine.

The storage section 570 stores model data 572, object property value data 574, individual-layer optical absorption coefficient data 575, component concentration data 576, scattered light time-resolved differential waveform data 578, and reference object optical characteristic data 579.

The model data 572 includes object model data 572A that includes the propagation optical path length distribution “Lₛₘ(t)” and the zero-absorption scattered light intensity temporal characteristics “Nₛ(t)” calculated for the object by a simulation process, and reference object model data 572B that includes the propagation optical path length distribution “Lᵣₘ(t)” and the zero-absorption scattered light intensity temporal characteristics “Nᵣ(t)” calculated for the reference object by a simulation process. A subscript “s” is attached to the characteristics corresponding to the object, and a subscript “r” is attached to the characteristics corresponding to the reference object (the details are described later using expressions).

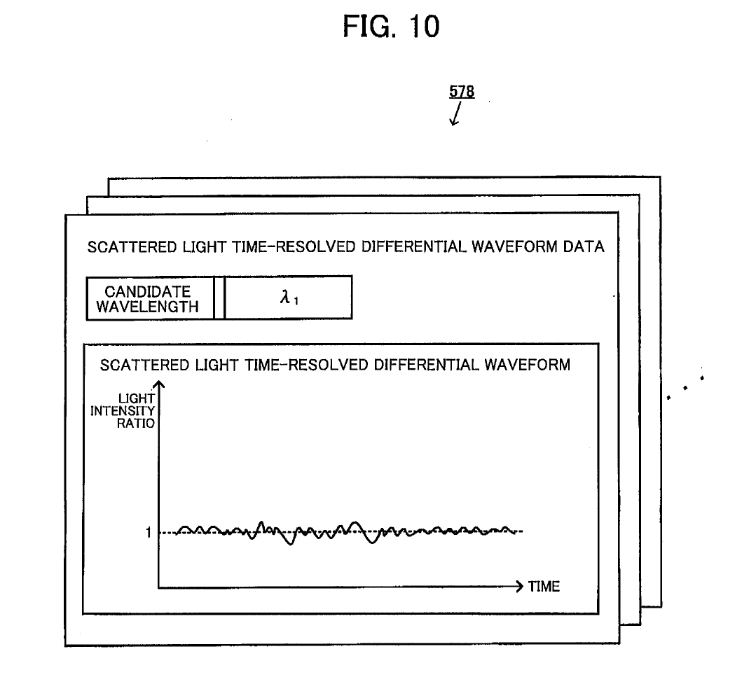

The scattered light time-resolved differential waveform data 578 indicates the scattered light time-resolved differential waveform (i.e., the temporal characteristics of the ratio of the first light intensity to the second light intensity). FIG. 10 illustrates a data configuration example of the scattered light time-resolved differential waveform data 578. The scattered light time-resolved differential waveform data 578 includes the candidate wavelength and the scattered light time-resolved differential waveform. In the second embodiment, since the reference object has optical characteristics similar to those of the object, a scattered light time-resolved differential waveform in which the value fluctuates around “1” is generated. Note that data about the number of steps when assigning a 16-bit value within the light intensity ratio range of “0.9 to 1.1” in a conversion process described later is stored as conversion data 578A.

The reference object optical characteristic data 579 is data about the optical characteristics of the reference object. For example, the reference object optical characteristic data 579 includes individual-layer optical absorption coefficient data 579A. The individual-layer optical absorption coefficient data 579A indicates the optical absorption coefficient of each layer of the reference object (i.e., the individual-layer optical absorption coefficient of the reference object). The individual-layer optical absorption coefficient data 579A is known data obtained in advance by measurement or the like, and is used to calculate the optical absorption coefficient of each layer of the object (i.e., the individual-layer optical absorption coefficient of the object).

2-3. Process Flow

FIG. 11 is a flowchart illustrating the flow of the second component concentration measurement process that is performed by the processing section 510 according to the second component concentration measurement program 577 stored in the storage section 570.

In a step T1, the model generation section 511 performs an object model generation process. More specifically, the model generation section 511 generates the propagation optical path length distribution “Lₛₘ(t)” and the zero-absorption scattered light intensity temporal characteristics “Nₛ(t)” by performing the Monte Carlo simulation (see the first embodiment), for example. The model generation section 511 stores these models in the storage section 570 as the object model data 572A.

The model generation section 511 then performs a reference object model generation process (step T2). More specifically, the model generation section 511 generates the propagation optical path length distribution “Lᵣₘ(t)” and the zero-absorption scattered light intensity temporal characteristics “Nᵣ₍ₜ₎” by performing the Monte Carlo simulation (see the first embodiment), for example. The model generation section 511 stores these models in the storage section 570 as the reference object model data 572B.

The scattered light time-resolved differential waveform generation section 514 performs the scattered light time-resolved differential waveform generation process according to the scattered light time-resolved differential waveform generation program 577A stored in the storage section 570 (step T3).

FIG. 12 is a flowchart illustrating the flow of the scattered light time-resolved differential waveform generation process.

The scattered light time-resolved differential waveform generation section 514 performs a loop E process on each candidate wavelength after the step A3 (steps B5 to B23). In the loop E process, the scattered light time-resolved differential waveform generation section 514 acquires the first light intensity and the second light intensity respectively from the first light detection section 313A and the second light detection section 313B after the step A9 (step B11). The scattered light time-resolved differential waveform generation section 514 calculates the ratio (light intensity ratio) of the first light intensity to the second light intensity (step B13).

The scattered light time-resolved differential waveform generation section 514 then performs the conversion process (step B15). In the second embodiment, the scattered light time-resolved differential waveform generation section 514 calculates the ratio of the first light intensity to the second light intensity using the reference object (i.e., a substance or a solution that has optical absorption characteristics and light scattering characteristics similar to those of the object). Since the object and the reference object have similar optical characteristics, the light intensity ratio is calculated to be close to “1”. In the second embodiment, a value indicated by a given number of bits is assigned within a given range around the value “1”.

For example, a 16-bit value is assigned within the light intensity ratio range of “0.9 to 1.1”. Specifically, 0.2=2¹⁶ steps, and one step is set to be “(0.2)/2¹⁶”. When the light intensity ratio is indicated by “X”, and the number of steps is indicated by “Y”, “X=0.9+((0.2)/2¹⁶)×Y”. In this case, the conversion data 578A that includes the number of steps “Y=(X−0.9)×2¹⁶/0.2” is stored in the storage section 570 as the scattered light time-resolved differential waveform data 578 (step B17). The scattered light time-resolved differential waveform generation section 514 then proceeds to a step B19.

The scattered light time-resolved differential waveform generation section 514 determines whether or not the light intensity ratio has been acquired for the entire optical path length range (step B19). When the scattered light time-resolved differential waveform generation section 514 has determined that the light intensity ratio has not been acquired for the entire optical path length range (step B19: No), the scattered light time-resolved differential waveform generation section 514 proceeds to the step A15. When the scattered light time-resolved differential waveform generation section 514 has determined that the light intensity ratio has been acquired for the entire optical path length range (step B19: Yes), the scattered light time-resolved differential waveform generation section 514 performs the process on the next candidate wavelength.

Again referring to FIG. 11 (second component concentration measurement process), when the scattered light time-resolved differential waveform generation process has completed, the processing section 510 acquires the propagation optical path length “Lₛₘ(tₖ)” of each layer of the object at the selected time “tₖ” from the propagation optical path length distribution “Lₛₘ(t)” included in the object model data 572A corresponding to the selected wavelength (step S13). The processing section 510 also acquires the zero-absorption scattered light intensity “Nₛ(tₖ)” at the selected time “tₖ” from the zero-absorption scattered light intensity temporal characteristics “Nₛ(t)” included in the object model data 572A corresponding to the selected wavelength (step S15).

Likewise, the processing section 510 acquires the propagation optical path length “Lᵣₘ(tₖ)” of each layer of the object at the selected time “tₖ” from the propagation optical path length distribution “Lᵣₘ(t)” included in the reference object model data 572B corresponding to the selected wavelength (step T13). The processing section 510 also acquires the zero-absorption scattered light intensity “Nᵣ(tₖ)” at the selected time “tₖ” from the zero-absorption scattered light intensity temporal characteristics “Nᵣ(t)” included in the reference object model data 572B corresponding to the selected wavelength (step T15).

The processing section 510 then performs an inverse conversion process (step T16). More specifically, the processing section 510 inversely converts the number of steps “Y” stored as the conversion data 578A by the conversion process in the step B15 into the light intensity ratio “X”. The processing section 510 thus acquires the ratio “Rᵣ(tₖ)/Rₛ(tₖ)” of the second light intensity “Rᵣ(tₖ)” to the first light intensity “Rₛ(tₖ)” of the scattered light at the selected time “tₖ” corresponding to the selected wavelength (step T17). The processing section 510 then performs the loop C process on the next selected time.

When the processing section 510 has performed the process in the steps S13 and T17 on each selected time, the processing section 510 terminates the loop C process (step S19). The optical absorption coefficient calculation section 515 then calculates the individual-layer optical absorption coefficient “μₐₘ” corresponding to the selected wavelength (step T21).

The optical absorption coefficient of each skin layer is calculated as described below. In the expression (3), a subscript “s” is attached to the characteristics corresponding to the object, and a subscript “r” is attached to the characteristics corresponding to the reference object. The ratio “Rₛ(t)/R₂(t)” of the first light intensity “Rₛ(t)” to the second light intensity “Rᵣ(t)” is shown by the following expression (10).

$$\begin{matrix}\frac{{R}_{s}^{′} ( t )}{{R}_{r}^{′} ( t )} = \frac{exp ( - {\sum }_{m = 1}^{M} {μ}_{asm} {L}_{sm}^{′} ( t ) ) {N}_{s}^{′} ( t )}{exp ( - {\sum }_{m = 1}^{M} {μ}_{arm} {L}_{rm}^{′} ( t ) ) {N}_{r}^{′} ( t )} \\ = \frac{{N}_{s}^{′} ( t )}{{N}_{r}^{′} ( t )} exp \{ - ( {\sum }_{m = 1}^{M} {μ}_{asm} {L}_{sm}^{′} ( t ) ) + ( {\sum }_{m = 1}^{M} {μ}_{arm} {L}_{rm}^{′} ( t ) ) \}\end{matrix} \qquad ( 10 )$$

The expression (10) can be rewritten into the following expression (11).

$$ln ( \frac{{N}_{s}^{′} ( t )}{{N}_{r}^{′} ( t )} \cdot \frac{{R}_{r}^{′} ( t )}{{R}_{s}^{′} ( t )} ) = ( {\sum }_{m = 1}^{M} {μ}_{asm} {L}_{sm}^{′} ( t ) ) - ( {\sum }_{m = 1}^{M} {μ}_{arm} {L}_{rm}^{′} ( t ) ) \qquad ( 11 )$$

Note that the expression (11) can be rewritten into the following expression (12) using the expression (4).

$$ln ( \frac{{N}_{s}^{′} ( t )}{{N}_{r}^{′} ( t )} \cdot \frac{{R}_{r}^{′} ( t )}{{R}_{s}^{′} ( t )} ) = \frac{1}{{N}_{s} ( t )} ( {\sum }_{m = 1}^{M} {μ}_{asm} {L}_{sm} ( t ) ) - \frac{1}{{N}_{r} ( t )} ( {\sum }_{m = 1}^{M} {μ}_{arm} {L}_{rm} ( t ) ) \qquad ( 12 )$$

The expression (11) or (12) corresponds to the expression (1) used in connection with the first embodiment. Therefore, the optical absorption coefficient “μₐ₁” of the epidermis layer, the optical absorption coefficient “μₐ₂” of the dermis layer, and the optical absorption coefficient “μ₄₃” of the subcutaneous tissue layer can be calculated in the same manner as in the first embodiment by utilizing the expression (11) or (12).

More specifically, the expression (12) can be rewritten into the following expression (13) using three different times.

$$\{ \begin{matrix}ln ( \frac{{N}_{s}^{′} ( {t}_{1} )}{{N}_{r}^{′} ( {t}_{1} )} \cdot \frac{{R}_{r}^{′} ( {t}_{1} )}{{R}_{s}^{′} ( {t}_{1} )} ) = ( {\sum }_{m = 1}^{M} {μ}_{asm} {L}_{sm}^{′} ( {t}_{1} ) ) - ( {\sum }_{m = 1}^{M} {μ}_{arm} {L}_{rm}^{′} ( {t}_{1} ) ) \\ ln ( \frac{{N}_{s}^{′} ( {t}_{2} )}{{N}_{r}^{′} ( {t}_{2} )} \cdot \frac{{R}_{r}^{′} ( {t}_{2} )}{{R}_{s}^{′} ( {t}_{2} )} ) = ( {\sum }_{m = 1}^{M} {μ}_{asm} {L}_{sm}^{′} ( {t}_{2} ) ) - ( {\sum }_{m = 1}^{M} {μ}_{arm} {L}_{rm}^{′} ( {t}_{2} ) ) \\ ln ( \frac{{N}_{s}^{′} ( {t}_{3} )}{{N}_{r}^{′} ( {t}_{3} )} \cdot \frac{{R}_{r}^{′} ( {t}_{3} )}{{R}_{s}^{′} ( {t}_{3} )} ) = ( {\sum }_{m = 1}^{M} {μ}_{asm} {L}_{sm}^{′} ( {t}_{3} ) ) - ( {\sum }_{m = 1}^{M} {μ}_{arm} {L}_{rm}^{′} ( {t}_{3} ) )\end{matrix} \qquad ( 13 )$$

The simultaneous equations shown by the expression (13) are solved using the propagation optical path length “Lₛₘ(tₖ)” and the zero-absorption scattered light intensity “Nₛ(tₖ)” of each layer of the object acquired in the steps S13 and S15, the propagation optical path length “Lᵣₘ(tₖ)” and the zero-absorption scattered light intensity “Nᵣ(tₖ)” of each layer of the reference object acquired in the steps T13 and T15, the light intensity ratio “Rᵣ(tₖ)/Rₛ(tₖ)” acquired in the step T17, and the individual-layer optical absorption coefficients “μₐᵣ₁”, “μₐᵣ₂”, and “μtₐᵣ₃” of the reference object included in the individual-layer optical absorption coefficient data 579A. The optical absorption coefficient “μₐₛ₁” of the epidermis layer, the optical absorption coefficient “μₐₛ₂” of the dermis layer, and the optical absorption coefficient “μₐₛ₃” of the subcutaneous tissue layer of the object are thus calculated.

After the optical absorption coefficient “μₐₛ₂” of the dermis layer of the object has been calculated, the concentration of each component contained in the dermis layer is calculated in the same manner as in the first embodiment using the expression (6) (step S25).

2-4. Advantageous Effects

According to the second embodiment, the concentration of each component contained in the object is calculated using the difference between the time-resolved waveform measured when applying the measurement light to the object and the reference time-resolved waveform measured when applying the measurement light to the reference material having known optical characteristics. More specifically, the optical absorption coefficient of each skin layer is calculated using the given expression based on the scattered light time-resolved differential waveform that is indicated by the ratio of the time-resolved waveform measured when applying the measurement light to the object to the reference time-resolved waveform. The concentration of glucose contained in the skin dermis layer is calculated using the resulting optical absorption coefficient.

The given conversion process is performed when generating the scattered light time-resolved differential waveform. The intensity of the measurement light has a time-resolved waveform as illustrated in FIG. 5, for example. Specifically, the light intensity may range from a small value to a large value. When expressing such a wide value range using a given number of bits (e.g., 16 bits), the value corresponding to one bit increases. According to the second embodiment, however, since the value range indicated by the ratio of the time-resolved waveforms is expressed by a given number of bits, the value corresponding to one bit can be reduced. This makes it possible to use a high-resolution value as the light intensity (light intensity ratio), so that the component concentration calculation accuracy can be improved as compared with the first embodiment.

2-5. Modifications

The second embodiment has been described above taking an example in which the optical absorption coefficient of each skin layer is calculated by the expression (13). Note that the optical absorption coefficient of each skin layer may be calculated by the following integral expression (14) duduced from the expression (13).

$$\{ \begin{matrix}{\int }_{τ1}^{τ2} ln ( \frac{{N}_{s}^{′} ( t )}{{N}_{r}^{′} ( t )} \cdot \frac{{R}_{r}^{′} ( t )}{{R}_{s}^{′} ( t )} ) {L}_{s 1}^{′} ( t ) d t + {\sum }_{m = 1}^{M} {μ}_{arm} {\int }_{τ1}^{τ2} {L}_{s 1}^{′} ( t ) {L}_{rm}^{′} ( t ) d t = {\sum }_{m = 1}^{M} {μ}_{asm} {\int }_{τ1}^{τ2} {L}_{s 1}^{′} ( t ) {L}_{sm}^{′} ( t ) d t \\ {\int }_{τ1}^{τ2} ln ( \frac{{N}_{s}^{′} ( t )}{{N}_{r}^{′} ( t )} \cdot \frac{{R}_{r}^{′} ( t )}{{R}_{s}^{′} ( t )} ) {L}_{s 2}^{′} ( t ) d t + {\sum }_{m = 1}^{M} {μ}_{arm} {\int }_{τ1}^{τ2} {L}_{s 2}^{′} ( t ) {L}_{rm}^{′} ( t ) d t = {\sum }_{m = 1}^{M} {μ}_{asm} {\int }_{τ1}^{τ2} {L}_{s 2}^{′} ( t ) {L}_{sm}^{′} ( t ) d t \\ {\int }_{τ1}^{τ2} ln ( \frac{{N}_{s}^{′} ( t )}{{N}_{r}^{′} ( t )} \cdot \frac{{R}_{r}^{′} ( t )}{{R}_{s}^{′} ( t )} ) {L}_{s 3}^{′} ( t ) d t + {\sum }_{m = 1}^{M} {μ}_{arm} {\int }_{τ1}^{τ2} {L}_{s 3}^{′} ( t ) {L}_{rm}^{′} ( t ) d t = {\sum }_{m = 1}^{M} {μ}_{asm} {\int }_{τ1}^{τ2} {L}_{s 3}^{′} ( t ) {L}_{sm}^{′} ( t ) d t\end{matrix} \qquad ( 14 )$$

### 3. Additional Embodiments

3-1. Application Example

The above embodiments have been described above taking an example in which the object is human skin. Note that the object is not limited thereto. For example, the component concentration measurement device may be incorporated in a measurement system such as a sugar content measurement device that measures the sugar content in fruit.

The component concentration measurement device may be used to measure the concentration of sugar (e.g., sucrose or lactose) other than glucose, or may be used to measure the concentration of each component contained in a solution (e.g., sodium chloride solution), for example. When using the above embodiments, the concentrations of water, proteins, and lipids can be calculated in addition to the concentration of glucose.

3-2. Light Source

The above embodiments have been described above taking an example in which a common light source emits the measurement light and the gate light. Note that a light source that emits the measurement light and a light source that emits the gate light may be separately provided as long as pulsed lights that are synchronized with each other can be generated.

The light source is not limited to a light source that generates single-shot pulsed light, but may be a light source that repeatedly generates pulsed light. In this case, the light intensity detected by the light detection section may be integrated over a given time, and the subsequent process may be performed by using the integrated light intensity.

3-3. Optical Shutter

In order to efficiently obtain the optical shutter effect, a lens or the like may be disposed in the stage preceding the Kerr material, and light may be condensed in the Kerr material, for example.

3-4. Light Intensity Detection

The light intensity may be acquired by counting the number of photons via photon counting detection taking account of a case where the measurement light is weak.

3-5. Calculation of Optical Absorption Coefficient and Component Concentration

The optical absorption coefficient and the component concentration may be calculated using a method based on multivariate analysis (e.g., principal component analysis or partial least squares (PLS) method).

3-6. Acquisition of Scattered Light Time-Resolved Waveform

The above embodiments have been described above taking an example in which almost the entire shape of the scattered light time-resolved waveform is acquired by setting a range in which almost the entire shape of the scattered light time-resolved waveform is obtained to be the optical path length range. Note that almost the entire shape of the scattered light time-resolved waveform need not necessarily be acquired, and only part of the shape corresponding to the time zone necessary for calculations may be acquired. It suffices to set a range in which part or the entirety of the shape of the scattered light time-resolved waveform is obtained to be the optical path length range.

Although only some embodiments of the invention have been described in detail above, those skilled in the art would readily appreciate that many modifications are possible in the embodiments without materially departing from the novel teachings and advantages of the invention. Accordingly, such modifications are intended to be included within the scope of the invention.

What is claimed is:

1. A component concentration measurement device comprising:
an irradiation section that applies measurement light to an object, the measurement light being pulsed light;
a condenser section that condenses emitted light from the object;
a detection section that detects light intensity;
a gate light guide section that guides gate light, and is configured so that an optical path length can be changed, the gate light being pulsed light that is synchronized with the measurement light;
an optical shutter section that allows light that has been condensed by the condenser section to pass through toward the detection section based on the gate light guided by the gate light guide section;
an optical path length control section that changes the optical path length of the gate light guide section; and
a calculation section that calculates a time-resolved waveform from a detection result of the detection section, and calculates a concentration of a component contained in the object.

2. The component concentration measurement device as defined in claim 1,
the calculation section including an optical absorption coefficient calculation section that calculates an optical absorption coefficient of the object using the time-resolved waveform and an optical path model of the pulsed light that propagates through the object, the calculation section calculating the concentration of the component contained in the object using the optical absorption coefficient calculated by the optical absorption coefficient calculation section.

3. The component concentration measurement device as defined in claim 1,
the calculation section calculating the concentration of the component contained in the object using a difference between the time-resolved waveform and a reference time-resolved waveform, the reference time-resolved waveform being a time-resolved waveform measured when applying the measurement light to a reference material having known optical characteristics.

4. The component concentration measurement device as defined in claim 1,
the optical shutter section being formed by providing a Kerr material between a pair of polarizers that are positioned so that transmission axes thereof are orthogonal to each other, and
the gate light guide section guiding the gate light to the Kerr material.

5. The component concentration measurement device as defined in claim 1, further comprising:
a light source that generates pulsed light; and
a splitter section that splits the pulsed light into the measurement light and the gate light.

6. The component concentration measurement device as defined in claim 1,
the calculation section calculating at least a concentration of glucose contained in the object.

7. A component concentration measurement method comprising:
guiding pulsed light that is synchronized with measurement light to an optical shutter section as gate light, the measurement light being pulsed light, and the optical shutter section allowing emitted light from an object when the measurement light has been applied to the object to pass through based on the gate light;
changing an optical path length of the gate light that is guided to the optical shutter section;
detecting intensity of light that has passed through the optical shutter section; and
calculating a time-resolved waveform from the intensity of the light detected while changing the optical path length, and calculating a concentration of a component contained in the object.
